(19) United States
(12) Patent Application Publication
(10) Pub. No.: US 2016/0275208 A1
(43) Pub. Date: Sep. 22, 2016

(54) METHODS AND SYSTEMS FOR ANALYZING CABLE OR PIPE

(71) Applicant: Chevron U.S.A. Inc., San Ramon, CA (US)

(72) Inventors: Antonio Carlos Falcao Critsinelis, Kingwood, TX (US); Christopher Allen Kassner, Houston, TX (US); Farzan Parsinejad, Houston, TX (US); Michael Joseph Knudsen, Houston, TX (US); Carsten Arnholm, Asker (NO)

(21) Appl. No.: 14/664,267

(22) Filed: Mar. 20, 2015

(51) Int. Cl. G06F 17/50

(52) U.S. Cl. CPC G06F 17/50

(57) ABSTRACT

Disclosed are methods, systems and computer readable storage media which facilitate the design of cables and pipes, including umbilicals, flexible pipes, optical cables, power cables, composite pipes, bundled pipes and combinations thereof. In one aspect, a computer implemented method includes, in response to input from a user in a plug-in interface in a graphical user interface within a computer-assisted design program, in a processor, executing instructions for receiving design information from a computer-assisted design program as well as receiving loading and deformation information from a global analysis software package for a cable or pipe having multiple components. A model is created using the design, loading and deformation information. The model is readable by a cable or pipe analysis software package. Thus the user is not required to manually generate the model of the cable or pipe readable by the cable or pipe analysis software package to be input into the cable or pipe analysis software package.

### FIELD

The present disclosure relates generally to computer implemented methods and systems for analyzing cable or pipe, and more specifically, to methods and systems for retrieving data signals from CAD files representing the cable or pipe and generating a model readable by cable or pipe analysis software in a graphical user interface environment.

### BACKGROUND

Different types of cable and pipe are commonly used in the offshore production of oil and gas. Such cable and pipe known for use in oil and gas production include umbilicals, bonded and unbonded flexible pipe, optical cable, power cable, composite pipe, and bundled pipe.

Umbilicals are commonly used to connect subsea equipment and surface equipment in the offshore production of oil and gas. Umbilicals typically contain a set of tubes, electrical cables, and/or fiber optic cables that are bundled together to supply control and/or power from a power source to subsea oil and gas operations and transmit information between a control station and subsea oil and gas operations. Umbilicals are characteristically very long, and usually connect a substation to electrical machines or another undersea substation. Umbilical tubes in particular are typically used for injection of fluid, such as hydraulic fluid or chemical inhibitors, to operate subsea equipment and improve flow assurance for oil and gas applications. Umbilicals for such applications often include cables which conduct electricity over long distances. Umbilicals also often include fiber-optic cables for transmitting data, control signals and sensing signals. Umbilicals are often connected at one end to a surface platform or floating production facility. This end is referred to commonly as the hang off point. Below this point, it is referred to as a riser in which the umbilical is subject to environmental loadings from ocean waves and currents. The point at which the umbilical contacts the seabed is commonly referred to as the touchdown point.

Designers of cable and pipe, including umbilicals, appreciate that the cable or pipe will experience high levels of mechanical stress and strain at particular points during installation and operation stages. For instance, stresses due to fatigue are particularly high at the hang off point and at the touchdown point. In the design process, it is important to analyze the cable or pipe to determine the fatigue life and extreme stresses that the cable or pipe may experience to ensure that this does not exceed design limits.

Global analysis software packages are used to evaluate an overall system behavior and identifies the loads imposed on the cable or pipe, whereas local analysis software packages are used to evaluate the effect of global loads to the cross-sectional elements. Thus designers of cable or pipe generally use known software packages to assist in these types of analyses. This generally involves generating code that is readable by cable or pipe analysis software packages. Generating such code becomes complicated due to the complexity of the cross sections of the cable or pipe containing multiple components and can be time-consuming and subject to human error.

It would be desirable to have a computer implemented system to facilitate the design and analysis of cable and pipe which would avoid the aforementioned limitations of current systems.

### SUMMARY

In one aspect, a computer implemented method is provided for analyzing a cable or pipe. The method includes, in response to input from a user in a plug-in interface in a graphical user interface within a CAD program, in a processor, executing instructions for:

receiving a first set of data signals corresponding to design information for the cable or pipe having multiple components from a computer-aided design file;

receiving a second set of data signals corresponding to loading and deformation information impacting the cable or pipe from a global analysis software package; and

generating a model of the cable or pipe based on the first set and the second set of data signals wherein the model is readable by a cable or pipe analysis software package.

The model can be analyzed in the cable or pipe analysis software package, and the results of the analysis can be displayed in a graphical user interface within the cable or pipe analysis software package.

In another aspect, a system is provided for generating a model of a cable or pipe for analysis of the cable or pipe. The system includes a processor and a memory coupled to the processor. The memory has stored thereon instructions that, if executed by the processor, result in the implementation of operations including providing a feature in a graphical user interface within a CAD program wherein a user can select the feature to initiate receiving a first set of data signals corresponding to design information for a cable or pipe having multiple components from a computer-aided design file and a second set of data signals corresponding to loading and deformation information impacting the cable or pipe from a global analysis software package. The operations also include generating a model of the cable or pipe based on the first set and the second set of data signals wherein the model is readable by a cable or pipe analysis software package.

In another aspect, a computer readable storage medium is provided that includes instructions stored therein that, when executed by a processor, cause the processor to provide a feature in a graphical user interface within a CAD program wherein a user can use the feature to initiate receiving a first set of data signals corresponding to design information for a cable or pipe having multiple components from a computer-aided design file and a second set of data signals corresponding to loading and deformation information impacting the cable or pipe from a global analysis software package. The instructions further cause processor to generate a model of the cable or pipe based on the first set and the second set of data signals wherein the model is readable by a cable or pipe analysis software package.

### DESCRIPTION OF THE DRAWINGS

These and other objects, features and advantages of the present invention will become better understood with reference to the following description, appended claims and accompanying drawings where:

FIG. 1 is a flowchart illustrating overall method steps according to an exemplary embodiment.

FIG. 2 is a schematic diagram illustrating the relationship between system components according to an exemplary embodiment.

FIGS. 3A-3B are views representing a subwindow in a GUI containing a cross-sectional view of an umbilical to be analyzed as provided by an umbilical CAD software package according to an exemplary embodiment.

FIGS. 4A-4C are views of various results of an umbilical analysis according to an exemplary embodiment.

### GLOSSARY

The following glossary may be useful in understanding the various descriptions of the embodiments that follow.

The term model refers to a set of mathematical equations formulated to represent the behavior of an article, process or system.

The term graphical user interface (GUI) is an input/output interface by which a user can provide input to a computer program or receive output from a computer program through the use of two-dimensional graphical representations on a monitor.

The term computer-aided design (CAD) program refers to any computer program, including a drawing function.

The term computer refers to a system including a memory, a processor, a user input device and a display device.

The term processor refers to a device that performs a set of steps according to a set of instructions.

The term user input device refers to a device such as a keyboard, mouse, pointing device, or the like for giving a certain input to the computer.

The term display device refers to a monitor capable of displaying two-dimensional graphical representations.

The term communication bus refers to any method of communication between multiple electronic assemblies in an electronic system.

The term memory refers to any data storage device that is readable by a computer, including, but not limited to, hard disks, magnetic (floppy) disks, compact discs, zip drives, and magnetic tape.

The term operating system (OS) refers to a collection of software that manages computer hardware resources and provides common services for computer programs.

The term computer program, or program, refers to a set of instructions executed by a computer's processor to perform a task

The term window refers to a section of a visual display on a display device.

The term sub window refers to a subdivided section of a window.

The term icon refers to an image on a display device that represents a file, program, web page or command.

The term menu refers to a list of choices from which a user can select using a pointing device within a GUI or a keyboard. Examples include a pull-down menu, pull-up menu, pop-up menu, cascade menu, multiple hierarchical menu and the like.

The term pointing device refers to a device for controlling the position of a cursor on a display device. Examples of a pointing device include a mouse, a touchpad, a trackball, a joystick and the like.

The term cursor refers to an indicator used to show the position on a display device that will respond to input from a keyboard or pointing device.

The term widget refers to an element on a display device that a user interacts with in a GUI. Examples of widgets include text boxes, buttons, hyperlinks, drop-down lists, check boxes, radio buttons and the like.

The term global analysis software package refers to software packages used to evaluate an overall system including cable or pipe and identify loads imposed on the cable or pipe.

The term cable or pipe analysis software package refers to software packages used to analyze cross-sections of cable or pipe, taking into account design information related to the cable or pipe and loads imposed on the cable or pipe as identified by global analysis software.

### DETAILED DESCRIPTION

In one embodiment, a computer implemented system is provided that allows a user to export design information corresponding to a cable or pipe from a CAD program in a file having a format that can be read by a cable or pipe analysis software package. The cable or pipe analysis software package can subsequently be used to open the exported file and conduct an analysis of the cable or pipe. The results of the analysis provided using the computer implemented system can be used to identify critical design parameters of the cable or pipe related but not limited to localized stresses.

The cable or pipe can be an umbilical, bonded or unbonded flexible pipe, optical cable, power cable, composite pipe, bundled pipe and combinations thereof.

In one embodiment, the cable or pipe is an umbilical having multiple components. Such umbilical components can include, for example, conductors, filler elements, insulation, semiconducting elements, steel armor, carbon rods, tapes, sheaths, steel tubes, stranded cables, stranded conductors, wires, power cables, optical fibers and the like.

In one embodiment, the system includes a processor and a memory coupled to the processor. The memory has instructions stored thereon which can be executed by the processor when initiated by a user in a graphical user interface within the CAD program. A feature can be provided in the graphical user interface so that the user may elect to initiate the export of relevant design information, meaning information or data that can be gleaned from the CAD file of the cable or pipe that would be useful for analysis of the cable or pipe by the cable or pipe analysis software package. In one embodiment, at least a portion of the design information can be extracted from the CAD file, in any suitable format, representing a two-dimensional cross-sectional design of a cable or pipe imported into the GUI.

Such relevant design information of the cable or pipe can include geometry information of the cable or pipe, cable or pipe component material information, cable or pipe friction information, cable or pipe component type information, cable or pipe component number information, cable or pipe component pitch information, cable or pipe component location information, lay angle information for helically wound components and combinations thereof.

By geometry information is meant shape and dimensions of individual cable or pipe components. For example, full circle, concentric circles, diameters of the components, diameter of the cable or pipe, cross-sectional area of the components, cross-sectional area of the cable or pipe, and the like. By cable or pipe component material information is meant material types and material compositions utilized in individual cable or pipe components. By cable or pipe friction information is meant coefficients of friction between any two given materials. By cable or pipe component type information is meant categories of cable or pipe components, for instance, conductors, filler elements, insulation, semiconducting elements, steel armor, tape shield, sheaths, steel tubes, stranded cables, stranded conductors, wires, power cables, optical fibers and the like. By cable or pipe component number information is meant a specific number of a cable or pipe component present in a particular cable or pipe design. By cable or pipe component pitch is meant information indicating the overall length of a helically wound component with respect to a given lay angle. By cable or pipe component location information is meant the relative positioning of individual cable or pipe components with respect to one another, including relative locations of centers of circles representing cable or pipe components.

When initiated by the user, the system extracts relevant design information in the form of data signals from the CAD file and from the data signals, generates a model of the cable or pipe in the form of code that can be read by the cable or pipe analysis software package. In one embodiment, the user has a further option in the GUI to select the individual cable or pipe components and manually assign properties, e.g., geometric and material properties (such as mechanical, electromagnetic and thermal) to each component.

The model can be saved in a file and stored in a computer memory. The file can be later accessed and opened by the cable or pipe analysis software package by a processor. In such case, the cable or pipe analysis software package receives data signals corresponding to the model for further manipulation according to the cable or pipe analysis software code. The further manipulation includes manual generation of additional code that defines outputs of results, contact interfaces between cable or pipe components, boundary conditions, and load cases, and then conducting an analysis on the model and displaying results of the analysis in a graphical user interface within the cable or pipe analysis software package. Based on the input loads generated by global analysis, the results of the local analysis can include stress, strain histories, deformation values and combinations thereof of at least one of the multiple cable or pipe components. These results can be used in a variety of ways such as in the calculation of component fatigue life and stress utilization factors.

In one embodiment, the GUI can be an object-oriented environment. The user can select the feature in the GUI through the use of any suitable user input device. In one embodiment, the GUI includes a drop-down menu providing an option which the user can click to export design information from the CAD file of the cable or pipe. The feature can also be a button which the user may click.

The plug-in interface can optionally have additional functionalities that enhance the utility of the system disclosed herein. For example, in one embodiment, the plug-in interface advantageously determines whether a cable or pipe component is a solid element having a solid cross-section or rather a hollow tubular element not having a solid cross-section. In one embodiment, the plug-in interface can divide complicated geometries into simple geometrical segments readable by the cable or pipe analysis software package. In one embodiment, the plug-in interface automatically categorizes various properties required by the cable or pipe analysis software package. For instance, in order to make the property data readable by the cable or pipe software analysis package, the plug-in interface can categorize properties such as coordinates and pitch for a given steel tube as cross-sectional information while inner diameter and wall thickness would be categorized as geometric information. Other property categories will readily be appreciated by those of ordinary skill in the art. In one embodiment, the plug-in interface can automatically define the number of intervals within a mesh to be generated for finite element analysis, based on the component geometry information. In one embodiment, the plug-in interface can generate code required to define contact interfaces for determination of friction between cable or pipe components.

In another embodiment, the system further includes the cable or pipe analysis software package. The cable or pipe analysis software package is capable of conducting an analysis on the model of the cable or pipe and displaying results of the analysis in a graphical user interface within the cable or pipe analysis software package.

In one embodiment, a computer readable storage medium is provided that has instructions stored therein that, when executed by a processor, cause the processor to:

provide a feature in a graphical user interface within a CAD program wherein a user can use the feature to initiate receiving a first set of data signals corresponding to design information for a cable or pipe having multiple components from a computer-aided design file; and generate a model of the cable or pipe based on the first set of data signals wherein the model is readable by a cable or pipe analysis software package.

In one embodiment, the computer readable storage medium further includes instructions stored therein that, when executed by a processor, cause the processor to create a library of previously generated models of cable or pipe wherein the library can be accessed by a user in a graphical user interface. In this way, a library of standard cables and pipes can be provided and added to over time for future reference by users of the system, eliminating the need to re-create each model. The plug-in interface can provide the user with the option to save a model to the library.

Suitable computer readable media include, but are not limited to, CD-ROMs, floppy disks, magnetic tapes, solid-state memories and the like.

Advantageously, the user is not required to manually input a model of the cable or pipe readable by the cable or pipe analysis software package into the cable or pipe analysis software package. The model of the cable or pipe is generated automatically in the background. Thus, the user does not need to manually generate code that is readable by the cable or pipe analysis software package. This saves time in the design process and eliminates human error.

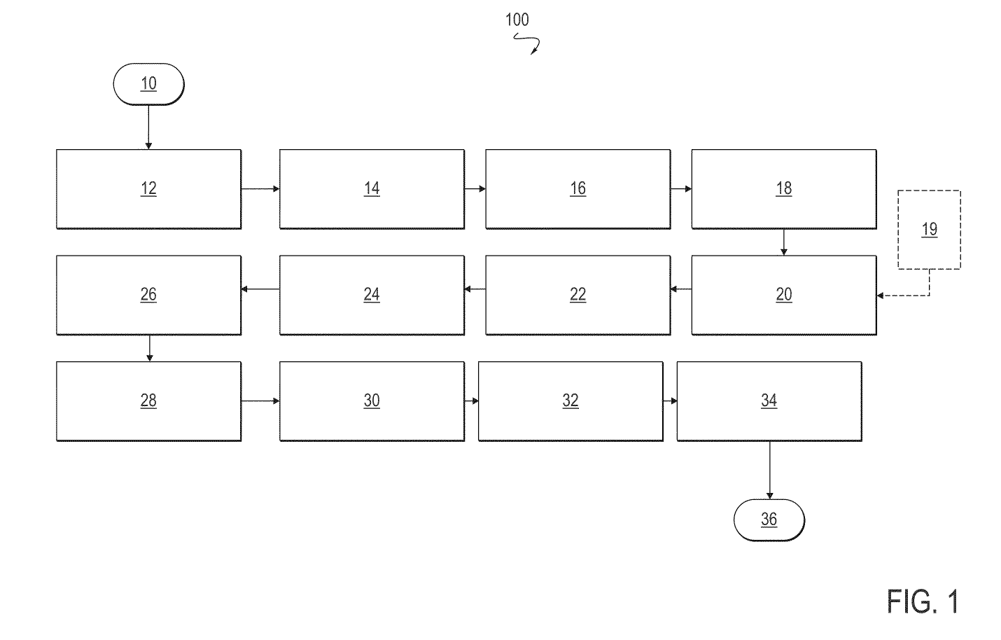

FIG. 1 is a flowchart illustrating steps of a method 100 according to one embodiment. According to the method, a user initiates the method steps within the GUI by an initiating act 10, such as by clicking an icon in the GUI to start the process. In step 12, the user uses a cable or pipe CAD software package to create a cable or pipe cross-section including the desired cable or pipe components. In step 14, using the CAD software package, the user defines corresponding material properties for the components created in step 12. In step 16, using the CAD software package, the user defines lay angles for any helically wound components within the cable or pipe. In step 18, the user selects all components contained with the cable or pipe cross-section and initiates extraction of a first set of data signals corresponding to the design information for the cable or pipe components selected. In optional step 19, the user initiates provision of a second set of data signals corresponding to the loading and deformation information for the cable or pipe from a global analysis software package. This second set of data signals can be manually entered or imported into the GUI.

In step 20, the feature generates a model based on the first set of data signals and the second set of data signals wherein the model is readable by a cable or pipe analysis software package. In step 22, the user selects a location to store the model in a computer memory in a location accessible by the cable or pipe analysis software package. In step 24, the user opens the model in the cable or pipe analysis software package. In step 26, the user manually inputs code in the cable or pipe analysis software package that dictates the desired output display of results, e.g. stresses in the cable or pipe. In step 28, the user manually inputs the code in the cable or pipe analysis software package that dictates the linkage of two or more individually defined geometry components for stability of the analysis, e.g., a tube and an associated sheath that have identical radial motions. In step 30, the user manually inputs code in the cable or pipe analysis software package that dictates the contact interfaces between one or more components such that contact stress can be considered in the analysis. In step 32, the user manually inputs code in the cable or pipe software analysis package that defines boundary conditions to the system, that can include boundary conditions for axial, transverse, and vertical displacements as well as bending, torsion and tension for either the entire cable or pipe or individual components. In step 34, at the initiation of a user, the cable or pipe analysis software conducts an analysis of the cable or pipe. The results of the analysis are output at step 36. Graphical files can be exported in common file formats such as .jpg, and .pdf.

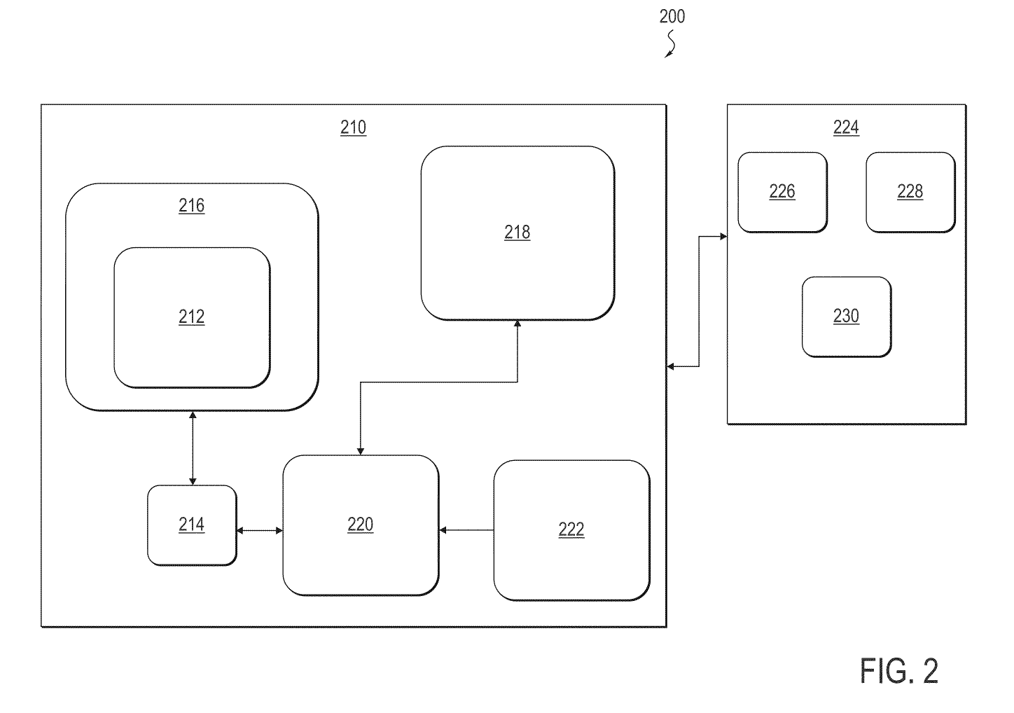

FIG. 2 is a schematic diagram illustrating the relationship between system components in a system 200 according to one embodiment. In one embodiment, a GUI 212, a CAD software program 216, a cable or pipe analysis software program 218 and a global analysis software program 222 reside within an operating system environment 210. A plug-in 214, e.g., in the form of a .DLL file 214 within the operating system environment 210, communicates with 216 when activated from within the GUI 212 and creates a feature in the GUI. The plug-in 214 also communicates with a computer memory 220 where it receives and stores data signals in a format readable by a cable or pipe analysis software program 218. The computer memory 220 further communicates with the global analysis software program 222 where it receives and stores data signals from the global analysis software any format readable by the cable or pipe analysis software program 218. In a particular example, the operating system 210 and the components therein communicate with a cable or pipe analysis software program license file 226, cable or pipe CAD software license file 228 and global analysis software license file 230 residing on a server 224.

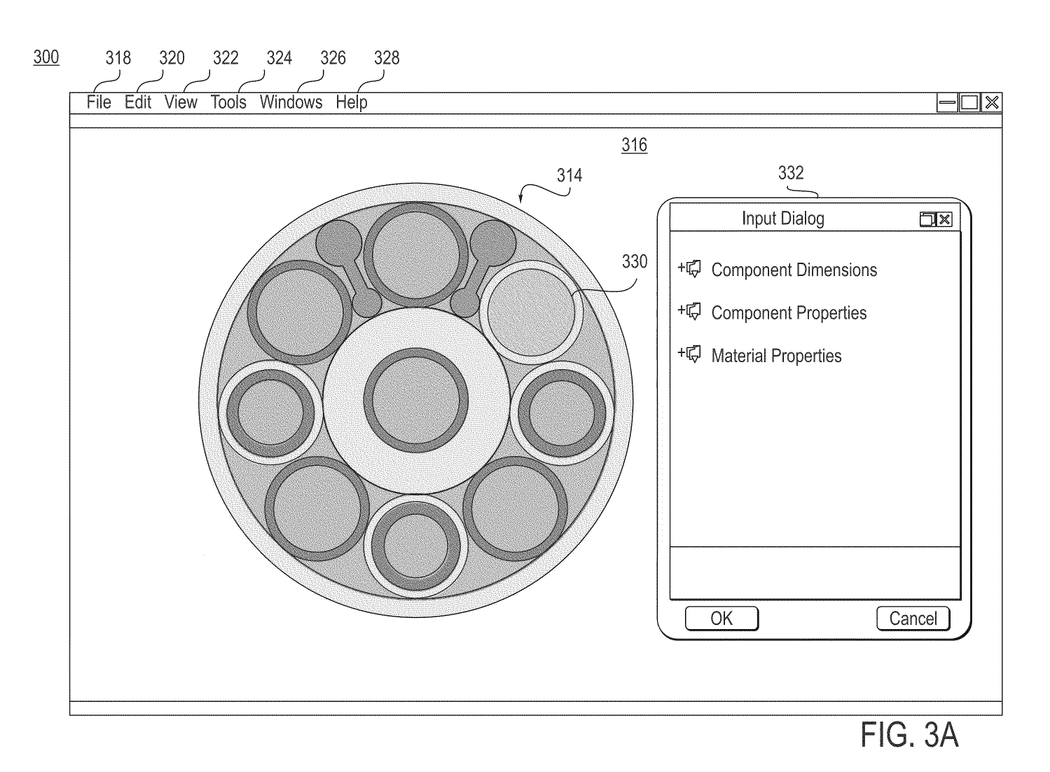

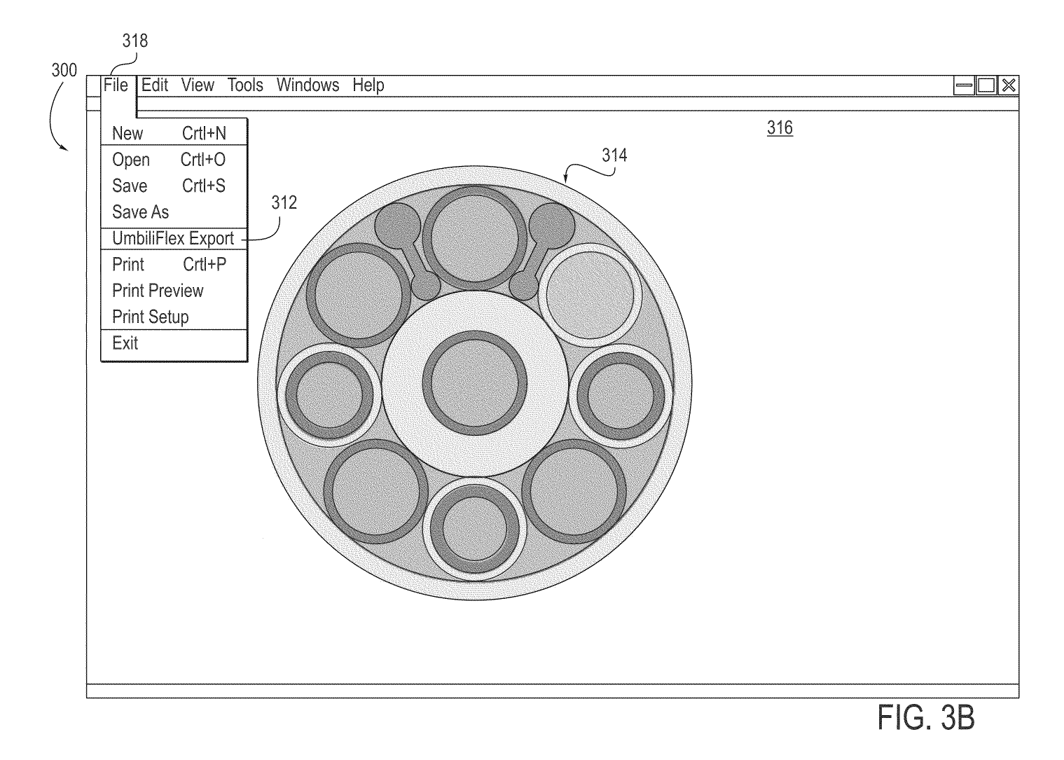

FIG. 3A is a view representing a window 300 in a GUI in an umbilical CAD software package according to one embodiment. As can be seen, the window 300 is divided into a number of subwindows. For instance, the central subwindow 316 is a graphical display for displaying the two-dimensional design of an umbilical. Subwindow 332 is available so that a user may define individual component geometry and material properties, in this case, for a steel tube 330. Options 318, 320 322, 324, 326, and 328 are available so that a user may switch to other subwindows, for example, a “Help” file. The umbilical model and its components 314 are generated by the user within the umbilical CAD software package and are displayed in 316 where changes can be easily made to the umbilical design. FIG. 3B shows the upper left-hand subwindow 312 that appears when the File option 318 is selected, including the feature entitled “UmbiliFlex Export . . . ” which allows a user to export design information in the form of data signals from the CAD file to the umbilical analysis software package. By clicking on the outermost component of the umbilical in subwindow 316 and selecting “UmbiliFlex Export . . . ” the user can then save a file to the computer memory in a format readable by the umbilical analysis software package. This can be .2IF format. Many other file formats would be suitable as will readily be appreciated by those of ordinary skill in the art. The user can then open the file within the umbilical analysis software package.

From within the software package, the user can view and modify software code that defines the umbilical model. The code can include subsets of code which can represent title blocks, analysis control parameters, component information, detailed component geometry, and component material properties. The umbilical model code can be displayed within a window or subwindow as the output generated automatically by the “UmbiliFlex Export . . . ” feature in FIG. 1, step 36.

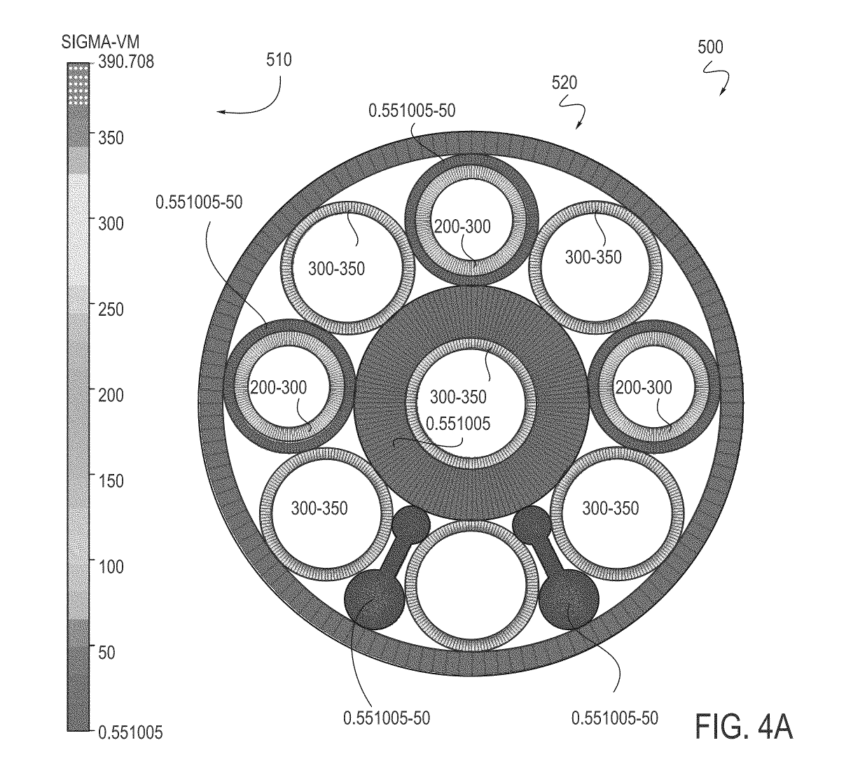

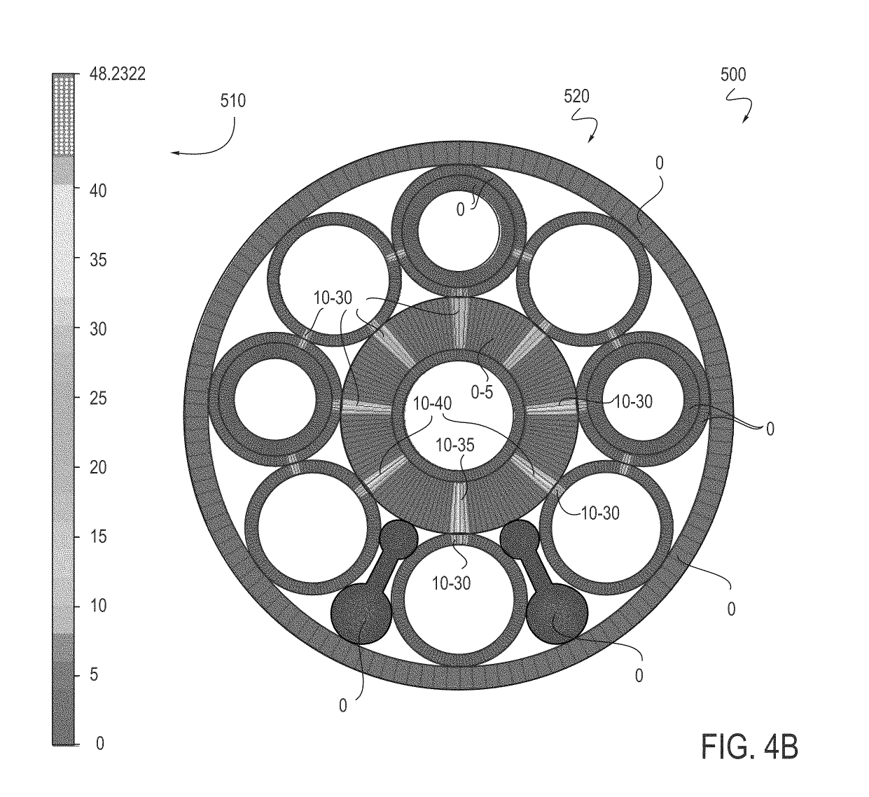

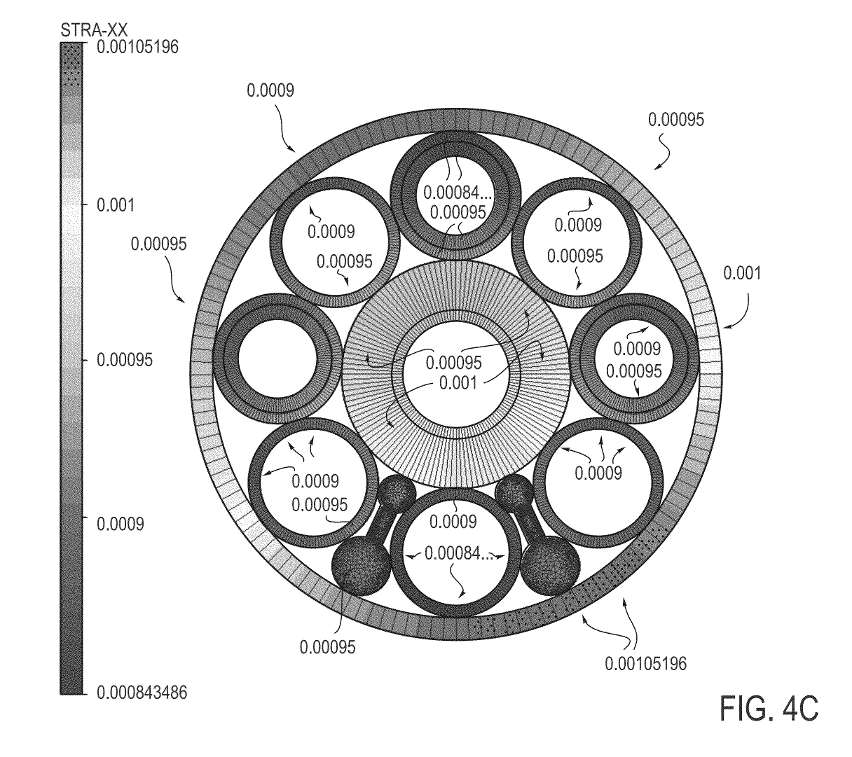

Results of an umbilical analysis of the umbilical illustrated in FIG. 3A are shown in FIGS. 4A-4C, as provided by an umbilical analysis software according to one embodiment. FIG. 4A shows one example of a display of Von Mises stress for all umbilical components based on the model. The display shown can be displayed in a GUI or in a report generated in the umbilical analysis software package. In the example shown, a legend 510 is provided including stress level by color. The cross-section of the umbilical 520 includes this stress information through the use of the colors according to the stress level. FIG. 4B similarly shows one example of contact stress between umbilical components based on the model. FIG. 4C similarly shows one example of strain in one direction for all umbilical components based on the model. Information can also be extracted in the form of graphs, e.g., stress vs. strain within the umbilical.

In one embodiment, the system provides a GUI to a user. The memory can store instructions to cause the processor to create the GUI. In one embodiment, the GUI includes commands such as “New,” “Load,” “Save,” “Export,” “Import,” “Print,” “Undo,” “Redo,” “Copy,” “Paste,” “Zoom,” “Rotate,” “Mirror,” “Exit,” etc. The user has the option to copy and paste text, numbers, and images from the GUI to other software applications such as, but not limited to, Microsoft Office products.

In one embodiment, the GUI includes a display having a feature such as a button which a user can click or otherwise execute to initiate the extraction of data signals. When the feature is selected, the plug-in extracts design information from the CAD file, and automatically generates a model of the cable or pipe readable by the cable or pipe analysis software package. No user involvement is needed in the automatic steps. The feature is selected once the user has selected the outermost sheath component of the cable or pipe with an input device such as a pointer.

Within the GUI, each component has associated features, including, but not limited to, physical dimensions and material properties.

In one embodiment, the GUI includes a window including a sub window for input values, a sub window for output values or results, a sub window to graphically display all components and a progress bar to indicate when a process is running.

In one embodiment, the user can further indicate any suitable operating conditions. Default settings can be provided for each of these conditions.

It should be noted that only the components relevant to the disclosure are shown in the figures, and that many other components normally part of a computer implemented system are not shown for simplicity.

Unless otherwise specified, the recitation of a genus of elements, materials or other components, from which an individual component or mixture of components can be selected, is intended to include all possible sub-generic combinations of the listed components and mixtures thereof. Also, “comprise,” “include” and its variants, are intended to be non-limiting, such that recitation of items in a list is not to the exclusion of other like items that may also be useful in the materials, compositions, methods and systems of this invention.

From the above description, those skilled in the art will perceive improvements, changes and modifications, which are intended to be covered by the appended claims.

What is claimed is:

1. A computer implemented method for analyzing a cable or pipe, comprising:
in response to input from a user in a plug-in interface in a graphical user interface within a CAD program, in a processor, executing instructions for:
a. receiving a first set of data signals corresponding to design information for the cable or pipe having multiple components from a computer-aided design file;
b. receiving a second set of data signals corresponding to loading and deformation information impacting the cable or pipe from a global analysis software package; and
c. generating a model of the cable or pipe based on the first set and the second set of data signals wherein the model is readable by a cable or pipe analysis software package.

2. The method of claim 1, further comprising:
d. conducting an analysis on the model in the cable or pipe analysis software package; and
e. displaying results of the analysis in a graphical user interface within the cable or pipe analysis software package.

3. The method of claim 1, further comprising:
storing the model in a memory for later processing.

4. The method of claim 1, wherein the cable or pipe comprises an umbilical, flexible pipe, optical cable, power cable, composite pipe, bundled pipe and combinations thereof.

5. The method of claim 1, wherein the design information for the cable or pipe comprises geometry information, component material information, friction information, component type information, component number information, component pitch information, component location information, lay angle information for helically wound components and combinations thereof.

6. The method of claim 1, wherein the results of the analysis include stress, strain histories, time traces, histograms and combinations thereof of at least one of the multiple components of the cable or pipe.

7. The method of claim 1, wherein the user is not required to manually input a model of the cable or pipe readable by the cable or pipe analysis software package into the cable or pipe analysis software package.

8. The method of claim 1, wherein the graphical user interface comprises a menu option which the user can select to initiate step (a).

9. A system for generating a model of a cable or pipe for analysis of the cable or pipe, comprising:
a processor; and
a memory coupled to the processor and having stored thereon instructions that, if executed by the processor, result in the implementation of operations comprising:
a. providing a feature in a graphical user interface within a CAD program wherein a user can select the feature to initiate receiving a first set of data signals corresponding to design information for a cable or pipe having multiple components from a computer-aided design file and a second set of data signals corresponding to loading and deformation information impacting the cable or pipe from a global analysis software package; and
b. generating a model of the cable or pipe based on the first set and the second set of data signals wherein the model is readable by a cable or pipe analysis software package.

10. The system of claim 9, further comprising the cable or pipe analysis software package, wherein the cable or pipe analysis software package is capable of conducting an analysis on the model of the cable or pipe; and displaying results of the analysis in a graphical user interface within the cable or pipe analysis software package.

11. The system of claim 9, wherein the design information for the cable or pipe comprises geometry information, component material information, friction information, component type information, component number information, component pitch information, component location information and combinations thereof.

12. The system of claim 9, wherein the cable or pipe comprises an umbilical, flexible pipe, optical cable, power cable, composite pipe, bundled pipe and combinations thereof.

13. A computer readable storage medium comprising instructions stored therein that, when executed by a processor, cause the processor to:
a. provide a feature in a graphical user interface within a CAD program wherein a user can use the feature to initiate receiving a first set of data signals corresponding to design information for a cable or pipe having multiple components from a computer-aided design file and a second set of data signals corresponding to loading and deformation information impacting the cable or pipe from a global analysis software package; and
b. generate a model of the cable or pipe based on the first set and the second set of data signals wherein the model is readable by a cable or pipe analysis software package.

14. The computer readable storage medium of claim 13, wherein the design information for the cable or pipe comprises geometry information, component material information, friction information, component type information, component number information, component pitch information, component location information and combinations thereof.

15. The computer readable storage medium of claim 13, wherein the cable or pipe comprises an umbilical, flexible pipe, optical cable, power cable, composite pipe, bundled pipe and combinations thereof.

16. The computer readable storage medium of claim 13, further comprising instructions stored therein that, when executed by a processor, cause the processor to create a library of previously generated models of cable or pipe wherein the library can be accessed by a user in a graphical user interface.
